(19) United States
(12) Patent Application Publication
(10) Pub. No.: US 2005/0188094 A1
(43) Pub. Date: Aug. 25, 2005

(54) Method and systems for implementing internet protocol to transaction capabilities part communication

(76) Inventor: Donald Y. Tinker, Denton, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/781,615

(22) Filed: Feb. 20, 2004

(51) Int. Cl. H04L 9/00

(52) U.S. Cl. 709/230

(57) ABSTRACT

Methods and systems for implementing Internet protocol (IP) to transaction capabilities part (TCAP) communications are described. The system may include one or more FSLEE applications, one or more Internet servers, one or more hypertext transport protocol HTTP clients, and a FSL IP gateway, in communication with the FSLEE applications, the Internet servers and the HTTP clients, that comprises instructions for operating in a HTTP mode or in a Stream mode that enable communications between the FSLEE application and the HTTP clients or Internet servers, respectively.

### BACKGROUND

Flexible Service Environment (FSLEE) is an environment and tool used to implement telecommunications services. Within FSLEEs there are a number of FSLEE applications. These applications communicate with each other through Transaction Capabilities Part (TCAP) messages.

Internet services and interfaces communicate with Transmission Control Protocol/Internet Protocol (TCP/IP) messages. Presently, there does not exist a gateway that provides a communication link between the Internet services and interfaces and FSLEE applications. There is no gateway that provides a protocolless link between FSLEE applications and the Internet. There is no gateway that allows HyperText Transport Protocol (HTTP) clients to request services from FSLEE applications. There is no gateway that implements IP to TCAP communications.

### SUMMARY

What are described are methods and systems for implementing internet protocol (IP) to transaction capabilities part (TCAP) communications. A method may include listening on an IP port for a hypertext transport protocol (HTTP) request from a HTTP client, receiving the HTTP request, decoding the HTTP request, determining an appropriate destination flexible service environment (FSLEE) application for the HTTP request, and forwarding the decoded HTTP request to the destination FSLEE application.

A method may also include waiting for a FSLEE application message from a FSLEE application, receiving the FSLEE application message, determining an appropriate destination Internet server for the FSLEE application message, opening a connection with the destination Internet server, and, forwarding FSLEE application message to the destination Internet server.

A method may also include listening on an IP port for messages from Internet servers, receiving a message from an Internet server, determining appropriate destination FSLEE application for the message, wrapping the message in TCAP message, and forwarding the wrapped message to the destination FSLEE application.

A system may include one or more FSLEE applications, one or more Internet servers, one or more hypertext transport protocol HTTP clients, and a FSL IP gateway, in communication with the FSLEE applications, the Internet servers and the HTTP clients, that comprises instructions for operating in a HTTP mode or in a Stream mode that enable communications between the FSLEE application and the HTTP clients or Internet servers, respectively.

A computer-readable medium may include instructions for listening on an IP port for a hypertext transport protocol (HTTP) request from a HTTP client, receiving the HTTP request, decoding the HTTP request, determining an appropriate destination flexible service environment (FSLEE) application for the HTTP request, and forwarding the decoded HTTP request to the destination FSLEE application.

A computer-readable medium may also include instructions for waiting for a FSLEE application message from a FSLEE application, receiving the FSLEE application message, determining an appropriate destination Internet server for the FSLEE application message, opening a connection with the destination Internet server, and, forwarding the FSLEE application message to the destination Internet server.

A computer-readable medium may also include instructions for listening on an IP port for messages from Internet servers, receiving a message from an Internet server, determining appropriate destination FSLEE application for the message, wrapping the message in TCAP message, and forwarding the wrapped message to the destination FSLEE application.

### DESCRIPTION OF THE DRAWINGS

FIG. 1 is a block diagram illustrating an embodiment of a system, including an FSL IP Gateway 10, for implementing IP to TCAP communications in an HTTP mode.

FIG. 2 is a flowchart illustrating an embodiment of a method for implementing IP to TCAP communications in an HTTP mode.

FIG. 3 is a block diagram illustrating an embodiment of a system, including an FSL IP Gateway 10, for implementing IP to TCAP communications in a first stream mode.

FIG. 4 is a flowchart illustrating an embodiment of a method for implementing IP to TCAP communications in a first stream mode.

FIG. 5 is a block diagram illustrating an embodiment of a system, including an FSL IP Gateway 10, for implementing IP to TCAP communications in a second stream mode.

FIG. 6 is a flowchart illustrating an embodiment of a method for implementing IP to TCAP communications in a second stream mode.

FIG. 7 is an embodiment of a server for uses in a system and method for implementing IP to TCAP communications.

### DETAILED DESCRIPTION

Flexible Service Environment (FSLEE) is a software service platform that enables rapid development and deployment of INS services by providing platform support for service execution modules known as Single Information Blocks (SIBs). FSLEE is a proven and well-known tool for quickly implementing efficient telecommunications services and provides many mechanisms for efficient manipulation of telephony messages using the industry-standard TCAP message definition. FSLEE applications provide the functionality of the FSLEE. Some exemplary FSLEE applications include: 1) Home Zone—a Network Provider application that allows user to pay different tariff amounts on Global System for Mobile Communication (“GSM”) calls depending on the origination point (e.g., the closer to home the cheaper the calls); 2) Prepay—a Network Provider Intelligent Network application that allows user to prepay subscriber tariffs in GSM networks; and, 3) Network Monitoring and Support—a Network Provider application that allows the operator to monitor usage in the network and route calls appropriately for cost savings. FSLEE applications typically run on Hewlett-Packard Company's NonStop™ Hostservers. Applications that run on NonStop™ Hostservers are NonStop™ server applications.

Flexible Service (“FSL”) Internet Protocol (IP) Gateway extends the functionality provided by FSLEE applications to the Internet. Today's telecommunications services usually involve various intelligent interfaces; the FSL IP Gateway 10 allows Internet interfaces to participate in these services.

The FSL IP Gateway 10 is an application, running on a host server (e.g., Hewlett-Packard Company's NonStop™ Hostserver), that encapsulates/wraps an IP packet into a Transaction Capabilities Application Part (TCAP) message, by creating a TCAP message with the IP packet as part of the TCAP message data, and sends the TCAP message to an FSLEE application. The FSL IP Gateway 10 may also be used with other applications designed to run on the NonStop™ Hostserver.

The FSL IP Gateway 10 also manages transmission control protocol (TCP)/IP connections between FSLEE applications and services that can connect to or accept connections from the host server. The embodiments of the FSL IP Gateway 10 described herein have two modes of operation: a stream mode and an HyperText Transport Protocol (HTTP) mode. In the stream mode, the FSL IP Gateway 10 provides a protocol-less link between an application and the Internet. The stream mode provides a protocol-less link because the FSL IP Gateway 10 does not act as an HTTP server, but simply passes packets back and forth, translating and wrapping them as necessary. In the HTTP mode, the FSL IP Gateway 10 uses a subset of the HTTP protocol to link any number of applications to data. In the HTTP mode, the FSL IP Gateway 10 acts as a web server, allowing HTTP clients to request service from host server applications using the HTTP PUT protocol.

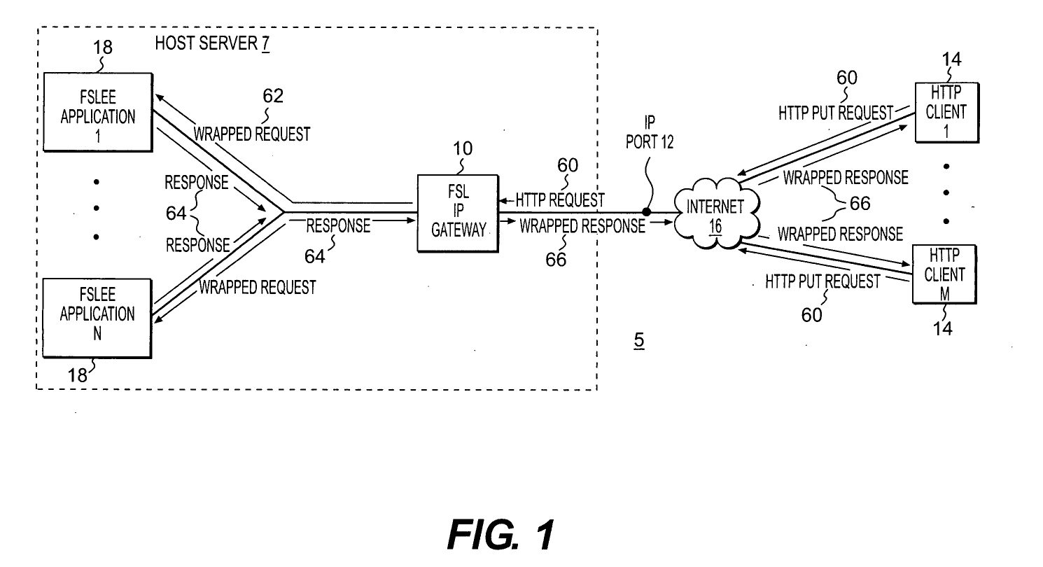

With reference now to FIG. 1 shown is a system 5 for implementing IP to TCAP communications under the HTTP mode of operation. System 5 includes FSL IP Gateway 10 with one or more IP ports 12 connected to one or more HTTP clients 14 via the Internet 16. The FSL IP Gateway 10 resides on a host server 7 with one or more FSLEE applications 18. Alternatively, FSLEE applications 18 may be located on other servers.

The FSL IP Gateway 10 listens on IP port 12 for HTTP PUT requests 60 from HTTP client 14. An HTTP PUT request is a request for sending data to a server. For example, the HTTP PUT request:

PUT /project/dirx/file.html HTTP 1.0
Content-type: text/html
Content-length: 103

[a blank line]

<HTML><HEAD><TITLE>Test</TITLE></HEAD>
<BODY><H1>TestTest</H1></BODY><HTML>

instructs a server to create the file /project/dirx/file.html and put the sent message data (i.e., the title “Test” and body “TestTest”) into this file.

The FSL IP Gateway 10 receives the HTTP PUT request 60, strips HTTP headers from the request 60, verifies the length of the request 60, decodes a universal resource locator (URL) of the request 60, and finds the appropriate FSLEE application 18 for the request 60. The FSL IP Gateway 10 determines the appropriate FSLEE application 18 by comparing the URL of the request 60 to a list of FSLEE applications 18 created during the configuration of the FSL IP Gateway 10. The FSL IP Gateway 10 wraps the decoded request in a TCAP message and forwards the wrapped request 62 to the appropriate FSLEE application 18. In the embodiment described herein, the FSL IP Gateway 10 can be configured to construct the TCAP message as a International Telecommunications Union (ITU) or American National Standards Institute (ANSI) TCAP message from an IP packet (the configuration determines which type of TCAP message to construct) or to encode an Extensible Markup Language (XML) representation of a TCAP message. An exemplary configuration of the FSL IP Gateway 10 is described below. The FSLEE application 18 sends a response 64 to the FSL IP Gateway 10. The FSL IP Gateway 10 creates an HTTP header for the response 64, wrapping the request 64, and forwards the wrapped response 66 to the requesting HTTP client 14 via the Internet 16.

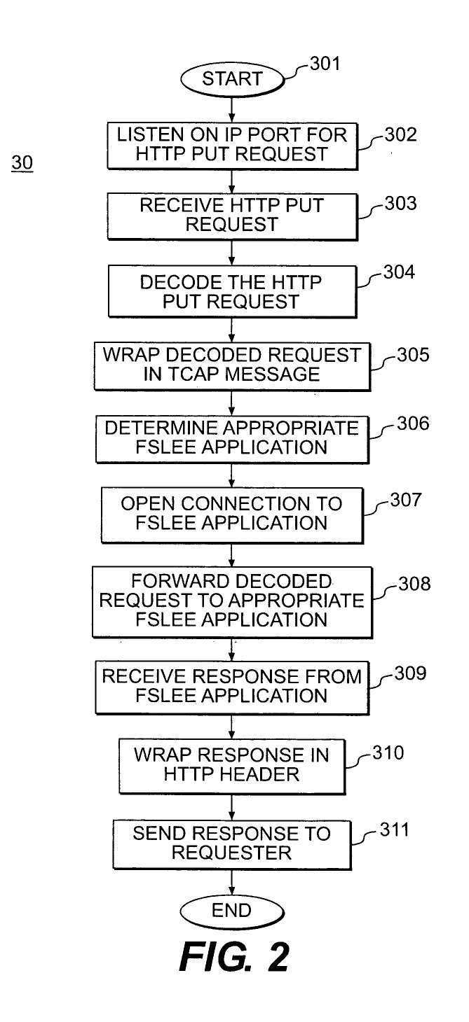

With reference now to FIG. 2, shown is an embodiment of a method 30 for implementing IP to TCAP communications per the HTTP mode of operations. Method 30 begins execution at block 301. The FSL IP Gateway 10 listens on an IP port for HTTP PUT requests 60, block 302. The listening step, block 302, comprises the FSL IP Gateway 10 monitoring the IP port for HTTP PUT requests 60. The FSL IP Gateway 10 may do this by registering with the operating system of the host server to receive messages sent to the IP port. When the FSL IP Gateway 10 “hears” an HTTP PUT request 60, i.e., an HTTP PUT request message is sent to and received at the IP port, the FSL IP Gateway 10 receives the HTTP PUT request 60 transmitted via a HTTP client 14, block 303. FSL IP Gateway 10 decodes the received HTTP PUT request 60, block 304. As described above, the decoding in block 304 includes stripping HTTP headers from the request 60, verifying the length of the request 60 and decoding the URL of the request 60. The FSL IP Gateway 10 wraps the decoded request, block 305. Using the decoded URL, the FSL IP Gateway 10 determines the appropriate FSLEE application 18, block 306. The FSL IP Gateway 10 may determine the appropriate FSLEE application 18 by comparing the URL of the request 60 to a list of FSLEE applications 18 created during the configuration (see below) of the FSL IP Gateway 10. The FSL IP Gateway 10 may use the intelligent network server (INS) message transfer system (MTS) to open a connection, block 307, and communicate with INS applications such as the FSLEE applications 18.

With continued reference to FIG. 2, FSL IP Gateway 10 forwards the wrapped request 62 to the appropriate FSLEE application 18, block 308. The FSL IP Gateway 10 may forward the wrapped request 62 using the INS MTS. Using the INS MTS, the FSL IP Gateway 10 can communicate with FSLEE applications 18 co-located with the FSL IP Gateway 10 or located on another server. The FSLEE application 18 processes the request 62 received from the FSL IP Gateway 10 and generates a response 64. The FSL IP Gateway 10 receives a response 64 from the FSLEE application 18, block 309. The FSL IP Gateway 10 wraps the response 64 in a HTTP header, block 310, and sends the wrapped response 66 to the requesting HTTP client, block 311. In operation, FSL IP Gateway 10 will continue to listen on the IP port for HTTP PUT requests 60, block 302, while performing method 30. FSL IP Gateway 10 may process multiple HTTP PUT requests 60, per method 30, simultaneously.

In the stream mode of operation, FSL IP Gateway 10 has two separate sub-modes of operation. In a first stream mode, FSL IP Gateway 10 acts as an application server to connect FSLEE applications with Internet (e.g., TCP/IP) servers. In this manner, FSLEE applications and the Internet servers may conduct both short and long-term conversations. An FSLEE application 18 can use FSL IP Gateway 10 to connect to an Internet service as needed and maintain that connection for as long as necessary. FSL IP Gateway 10 provides the communication portion of this function. Upper level protocols such as data format and application control are service issues that the FSLEE applications address.

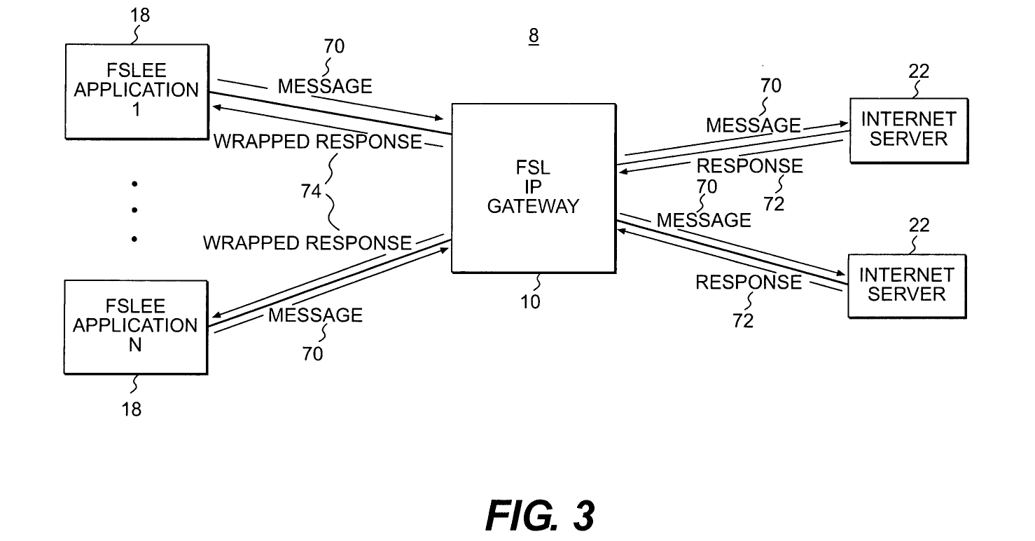

With reference now to FIG. 3, shown is a system 8 for implementing IP to TCAP communications in the first stream mode of operations. System 8 includes FSL IP Gateway 10 connected with a FSLEE application 18 and a plurality of Internet (e.g., TCP/IP) Servers 22, connected via the Internet 16. FSL IP Gateway 10 receives a message 70 from the FSLEE application 18. In response to this message 70, FSL IP Gateway 10 opens a connection to the appropriate Internet Server 22. FSL IP Gateway 10 may open the connection by creating a TCP session between the host server on which FSL IP Gateway 10 is running and the Internet Server 22.

FSL IP Gateway 10 delivers the message 70 to the Internet Server 22. The Internet Server 22 processes the message 70 and generates a response 72, if necessary. FSL IP Gateway 10 receives a response 72, wraps the response 72 in a pre-configured TCAP message (e.g., as described above with reference to FIG. 1) and delivers that TCAP message (the wrapped response 74) to the FSLEE application 18. The connection to the Internet Server 22 is maintained until closed by the Internet Server 22. FSL IP Gateway 10 generally does not close the connection unless an error occurs, but the connection may be reopened if necessary to send another message.

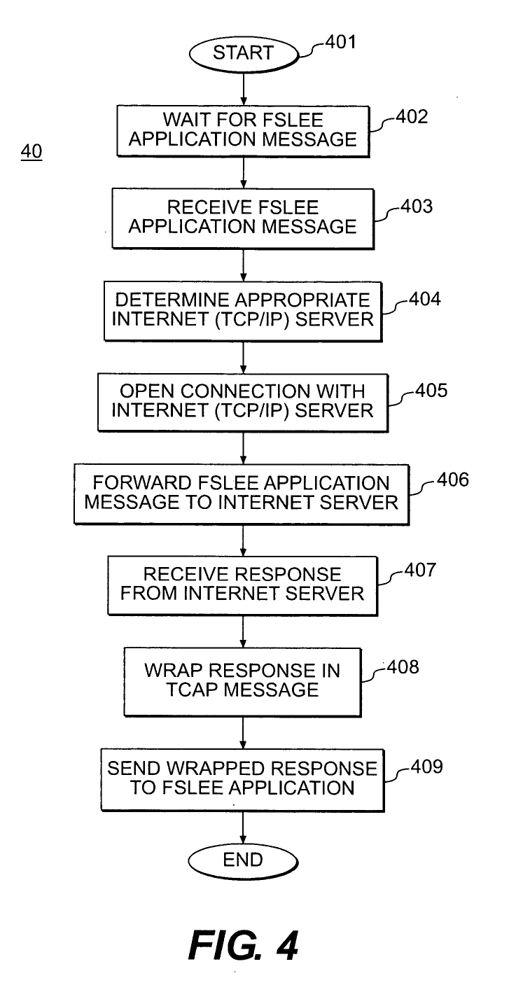

With reference now to FIG. 4, shown is a method 40 of implementing IP to TCAP communications in the first stream mode. Method 40 begins execution in block 401. FSL IP Gateway 10 waits for an FSLEE application message 70, block 402. FSL IP Gateway 10 receives an FSLEE application message 70, block 403, from an FSLEE application 18. As discussed above, FSLEE applications 18 may be co-located with the FSL IP Gateway 10 on host server or remotely located on a different server or servers. FSL IP Gateway 10 determines the appropriate Internet Server 22, block 404. FSL IP Gateway 10 may determine the appropriate Internet Server 22 by comparing the FSLEE application 18 sending the FSLEE application message 70 to a list of FSLEE applications 18 and corresponding Internet Servers 22 created during the configuration of the FSL IP Gateway 10. The list may include one Internet Server 22 per FSLEE application 18. The FSL IP Gateway 10 opens the connection with the Internet Server 22, block 405. The FSL IP Gateway 10 may open the connection by creating a TCP session between the host server on which FSL IP Gateway 10 is running and the Internet Server 22.

With continued reference to FIG. 4, the FSL IP Gateway 10 forwards the FSLEE application message 70 to the Internet Server 22, block 406. The Internet Server 22 processes the message 70 and generates a response 72. The FSL IP Gateway 10 receives the response 72 from the Internet Server 22, block 407. The FSL IP Gateway 10 wraps the response 72 in a TCAP message, block 408, and sends the wrapped response 74 to the FSLEE application 18, block 409. The FSL IP Gateway 10 may await additional FSLEE application messages 70, block 402, while performing method 40. The FSL IP Gateway 10 may process multiple FSLEE application messages 70, per method 40, simultaneously.

In a second stream mode of operation, FSL IP Gateway 10 may act as a transport/layer gateway providing a way for FSLEE applications and TCP/IP services to communicate using their own protocols. In this second stream mode, FSL IP Gateway 10 acts as a “pipe” between an FSLEE application and one or more Internet applications, forwarding information without protocol overhead in either direction. A TCP/IP client that can send and receive Basic Encoding Rules (BER)-encoded data is an example of a TCP/IP service that can communicate with FSLEE applications in this operational mode.

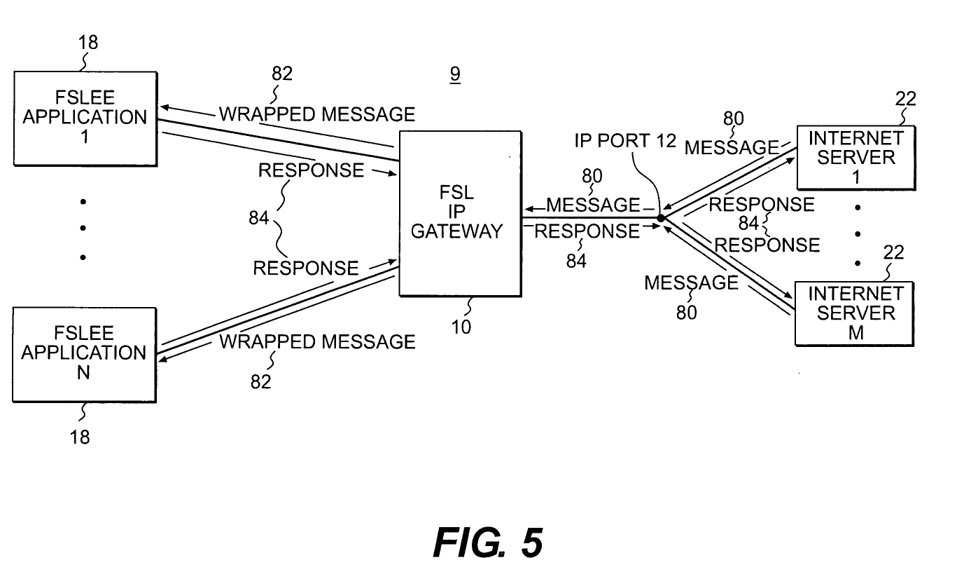

With reference now to FIG. 5, shown is a system 9 for implementing IP to TCAP communications in the second stream mode. System 9 includes FSL IP Gateway 10 listening on IP port 12 for messages 80 from Internet (e.g., TCP/IP) Servers 22. FSL IP Gateway 10 is connected to one or more FSLEE applications 18. As discussed above, FSL IP Gateway 10 may be co-located with FSLEE applications 18 on the same server or remotely located on different servers. FSL IP Gateway 10 listens on IP port 12 for messages 80 from Internet Servers 22. When receiving a message 80 from Internet Server 22 on IP port 12, FSL IP Gateway 10 opens a connection to the appropriate FSLEE application 18, wraps the message in a preconfigured TCAP message (e.g., as described above with reference to FIG. 1) and delivers the wrapped message 82 to FSLEE application 18.

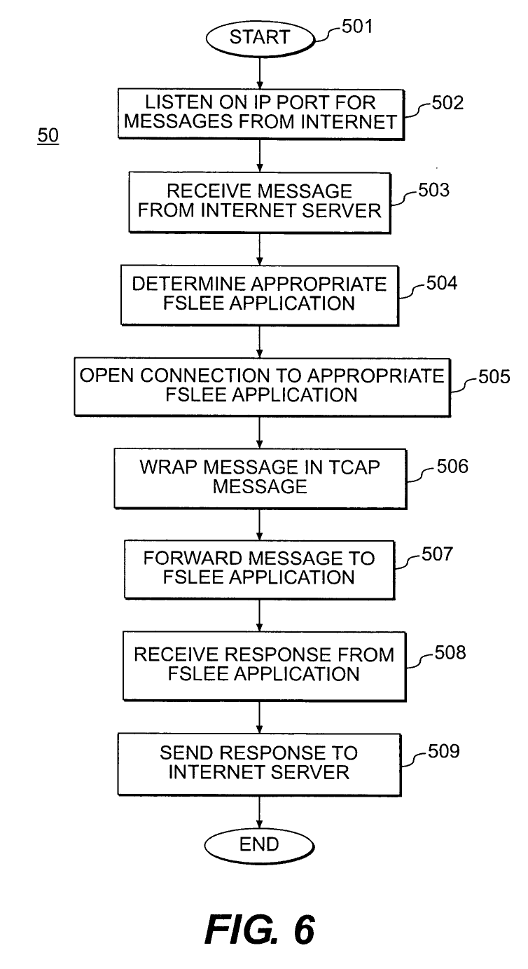

With reference now to FIG. 6, shown is a method 50 for implementing TCP/IP communications in the second stream mode. Method 50 begins execution at block 501. FSL IP Gateway 10 listens on IP port 12 for messages 80 from Internet 22, block 502. The messages from the Internet may be from Internet (e.g., TCP/IP) servers. FSL IP Gateway 10 receives messages 80 from the Internet Server 22, block 503. FSL IP Gateway 10 determines the appropriate FSLEE application 18 from the received message 80, block 504. FSL IP Gateway 10 opens a connection to the appropriate FSLEE application 18, block 505. FSL IP Gateway 10 may create this connection to the FSLEE application 18 using the INS MTS between itself and the FSLEE application 18.

FSLEE application 10 wraps the message 80 in a pre-configured TCAP message, block 506. FSL IP Gateway 10 forwards the wrapped message 82 to the FSLEE application 18, block 507. The FSLEE application 18 processes the wrapped message 82 and generates a response 84, if necessary. FSL IP Gateway 10 receives the response 84 from the FSLEE application, block 508, and sends the response 84 to the Internet Server 22 that sent the original message 80, block 508. While executing method 50, FSL IP Gateway 10 may listen on IP ports for additional messages 80 from one or more Internet Servers 22, block 502. Indeed, FSL IP Gateway 10 may process multiple messages 80 from Internet Servers 22 and FSLEE applications, per method 50, simultaneously.

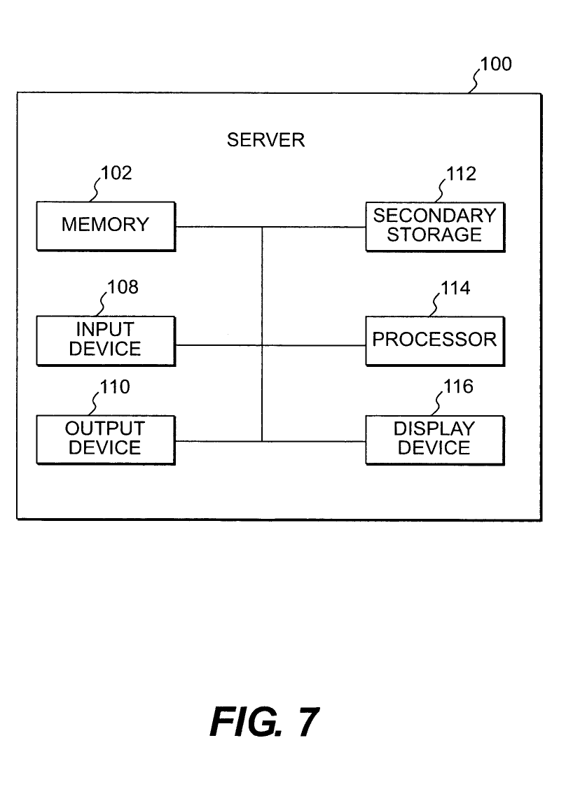

With reference now to FIG. 7, shown is a block diagram illustrating an exemplary host server. Servers on which FSLEE applications 18 reside and Internet Servers 22 may be similarly configured.

Server 100 typically includes a memory 102, a secondary storage device 112, a processor 114, an input device 108, a display device 116, and an output device 110. Memory 102 may include RAM or similar types of memory, and memory 102 may store one or more applications (e.g., FSLEE applications, FSL IP Gateway 10, etc.) for execution by processor 114. Secondary storage device 112 may include a hard disk drive, floppy disk drive, CD-ROM drive, or other types of non-volatile data storage. Processor 114 executes the application(s), which is stored in memory 102 or secondary storage 112, or received from the Internet or other network. Input device 108 may include any device for entering information into server 100, such as a keyboard, mouse, cursor-control device, touch-screen, microphone, digital camera, video recorder or camcorder. Display device 116 may include any type of device for presenting visual information such as, for example, a computer monitor or flat-screen display. Output device 110 may include any type of device for presenting a hard copy of information, such as a printer, and other types of output devices include speakers or any device for providing information in audio form.

Server 100 may store a database structure in secondary storage 112, for example, for storing and maintaining information need or used by the application(s). Also, processor 114 may execute one or more software applications in order to provide the functions described in this specification, specifically in the methods described above, and the processing may be implemented in software, such as software modules, for execution by computers or other machines. The processing may provide and support web pages and other GUIs. The GUIs may be formatted, for example, as web pages in HyperText Markup Language (HTML), XML or in any other suitable form for presentation on a display device.

Although server 100 is depicted with various components, one skilled in the art will appreciate that the servers can contain additional or different components. In addition, although applications, instructions, software, modules, etc., for performing the above-described functions are described as being stored in memory, one skilled in the art will appreciate that these applications, instructions, software, modules, etc., can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as server 100, to perform a particular method.

The below describes an exemplary configuration of an embodiment of FSL IP Gateway 10. FSL IP Gateway 10 functionality may be provided through a single executable file. FSL IP Gateway 10 may be installed by copying the single executable file to the node (e.g., server) where FSL IP Gateway 10 is to reside. Configuration parameters in the executable file control how FSL IP Gateway 10 works.

In an embodiment, FSL IP Gateway 10 includes six files that can assist in configuring FSL IP Gateway 10.

| | |
|---|---|
| ASUMCONF | This file contains a template for entering application |
| | summary records. This file is edited to include the |
| | parameters chosen to configure the Gateway. |
| ASUMLOAD | This file contains configuration information for loading |
| | the records in ASUMCONF. This file is edited include |
| | the correct information for reading the ASUMCONF file. |
| LOADASUM | This file is a command file which uses ASUMLOAD and |
| | ASUMCONF to load the application summary data into |
| | the node. After ASUMCONF and ASUMLOAD are |
| | correctly edited, run (using OBEY) to install the Gateway |
| | into the node. |
| FIFOCONF | This file contains templates for entering Process |
| | Descriptions and Process Input Parameter records into the |
| | node database. This file is edited to include the |
| | parameters chosen to configure the Gateway. |
| FIFOLOAD | This file contains templates and configuration |
| | information which is loaded into the database. |
| | This file is edited include the correct information |
| | for reading the FIFOCONF file. |
| LOADFIFO | This file is a command file which uses FIFOLOAD and |
| | FIFOCONF to load the configuration into the node |
| | database. After correctly editing FIFOCONF and |
| | FIFOLOAD, this file is run (using OBEY) to install the |
| | Gateway into the Node. |

The following describes exemplary steps for configuring an FSL IP Gateway 10 and the parameters that create a configuration.

Several parameters define how FSL IP Gateway 10 should perform its tasks. Some of the parameters are general, and apply to all modes of operation (i.e., the HTTP mode and stream modes described above); others are specific to a certain mode; still others are different depending on the mode chosen.

These parameters apply to all uses of the FSL IP Gateway 10 in this embodiment.

| Parameter | Description |
|---|---|
| ALLOWED- | If the FSL IP Gateway 10 is to refuse connections |
| HOSTS-FILE | from all but a set of authorized hosts, this parameter |
| | is included in the configuration. The value of the |
| | parameter is the name of a file containing a list of |
| | authorized hosts (either DNS host names or IP |
| | addresses), one per line. The file OKHOSTS, |
| | provided with the application, is a non-working |
| | example of this. If this parameter is not included, |
| | the FSL IP Gateway 10 will accept connections |
| | from any host. If the parameter value is an empty |
| | file, the FSL IP Gateway 10 will refuse all |
| | connections. If the file does not exist, the FSL IP |
| | Gateway 10 will complain and exit. |
| UNDER-THE- | If the application is going to be run outside the |
| NODE | node, include this parameter and set the parameter |
| | to the value “FALSE”. If running under the node, |
| | the parameter need not appear or may be set to |
| | “TRUE”. |
| READLOOPTIME | The number of seconds to wait for a message to |
| | arrive (either from an application or the IP network) |
| | before retrying. If CPU usage is high, this number |
| | may need to be increased. If performance is not |
| | adequate, this number may need to be reduced. |

As an HTTP server, the FSL IP Gateway 10 listens on an IP port 12 for HTTP PUT requests and the FSL IP Gateway 10 decodes the requests and sends them to the appropriate FSLEE application 18, as described above with reference to FIGS. 1 and 2. FSL IP Gateway 10 then wraps the response in an HTTP header and returns the wrapped response to the requester. The parameters that configure the Gateway to perform as an HTTP server are:

| Parameter | Description |
|---|---|
| NETWORK- | HTTP |
| PROTOCOL | |
| INITIATOR | NETWORK |
| LISTENING- | An appropriate ID of a port on the host system. The |
| PORT-ID | FSL IP Gateway 10 will listen on this port for |
| | HTTP requests. |
| ALLOW-DEBUG | This parameter is set to “true” to enable the use of |
| | the “/debug” path to print incoming and outgoing |
| | messages |
| DEBUG-FILE | A file into which debug entries (enabled with the |
| | ALLOW-DEBUG flag) are to be written. |

The FSL IP Gateway 10 knows which application should receive each HTTP request by decoding the URL in the HTTP header. A URL is defined (in RFC 2616) as http_URL=“http:” “//” host [“:” port] [abs_path [“?” query]].

The FSL IP Gateway 10 uses the abs_path component of the URL to find the target application (e.g., FSLEE application 18). FSL IP Gateway 10 expects the abs_path to be defined as a parameter whose value is a task ID and server class pair to which the message should be sent. For example, if configured:
HTTP Server Target Parameter
FSLAPP 40,12
then a message sent to
   http://hostserver.mydomain.com/FSLAPP
      would wrap the request into a TCAP message and send the wrapped request to task ID 40, server class 12. Therefore, a parameter is configured for each HTTP target (e.g., FSLEE application 18) that the FSL IP Gateway 10 will serve.

As an application server for the first stream mode, the FSL IP Gateway 10 waits for a specific FSLEE application 18 to send the FSL IP Gateway 10 a message, as described above with reference to FIGS. 3 and 4. The FSL IP Gateway 10 then connects to an Internet Server 22 and sends the message. Any responses are returned to the FSLEE application 18. The connection to the Internet Server 22 is maintained until closed by the Internet Server 22 (in most embodiments, the FSL IP Gateway 10 does not close the connection unless an error occurs), but reopens if necessary to send another message.

| Parameter | Description |
|---|---|
| NETWORK- | STREAM |
| PROTOCOL | |
| INITIATOR | SERVER |
| SENDING- | The IP port to which messages should be sent. |
| PORT-ID | |
| SENDING- | The host name (DNS name) or IP address (e.g., of |
| HOST-ID | the FSLEE application server) to which messages |
| | should be sent by the FSL IP Gateway 10. |
| LISTENING- | FSL IP Gateway 10 will listen for the connection |
| PORT-ID | established to the sending host for responses. If this |
| | parameter is configured, FSL IP Gateway 10 will |
| | also listen on this port for responses. After creating |
| | a connection to the sending host, the FSL IP |
| | Gateway 10 listens on this port for a connection |
| | from the same host; if a connection gets established, |
| | FSL IP Gateway 10 listens on the connection for |
| | responses. |

As a transport gateway for the second stream mode, the FSL IP Gateway 10 listens on an IP port 12 and opens a connection to an FSLEE Application 18, then forwards messages back and forth between the FSLEE Application 18 and the Internet Server 22, as described above with reference to FIGS. 5 and 6. FSL IP Gateway 10 can, as an application server for the first stream mode, also listen on an alternative port.

| Parameter | Description |
|---|---|
| PROTOCOL | STREAM |
| INITIATOR | BOTH |
| SENDING- | The IP port to which messages should be sent. |
| PORT-ID | |
| SENDING- | The host name (DNS name) or IP address (e.g., of |
| HOST-ID | the FSLEE application server) to which messages |
| | should be sent by the FSL IP Gateway 10. |
| LISTENING- | The FSL IP Gateway 10 will listen on the |
| PORT-ID | connection established to the sending host for |
| | responses. If this parameter is configured, FSL IP |
| | Gateway 10 will also listen on the port identified by |
| | the Listening-Port-ID for responses. After creating |
| | a connection to the sending host, FSL IP Gateway |
| | 10 listens on the Listening-Port for a connection |
| | from the same host; if a connection gets established, |
| | FSL IP Gateway 10 listens on the connection for |
| | responses. |
| STREAM-TASK-ID | The task-id of the FSLEE application to which to |
| | connect. |
| STREAM- | The server-class of the FSLEE application to which |
| SERVER-CLASS | to connect. |

The following parameters are also set in the FSL IP Gateway 10 configuration files:

| Parameter | Description |
|---|---|
| OPERATION- | An operation code of the message which the FSL IP |
| CODE | Gateway 10 sends to FSLEE application. This is |
| | specified as a decimal number. This corresponds to |
| | the code in a Operation Handling File (see below) |
| | and the message operation code. |
| APP-CONTEXT | The application context of the message set |
| | containing the message which FSL IP Gateway 10 |
| | sends to FSLEE application. This is specified as a |
| | hexadecimal number. This corresponds to the |
| | Application Context Name in the Application |
| | Context Map File. |
| ELEMENT-TAG | This parameter is an ASN.1 tag in the TCAP |
| | message which denotes the contained IP message. |
| | The element in the message denoted by the |
| | Operation Code with this tag number is used as the |
| | token into which the FSL IP Gateway 10 puts the IP |
| | message. |

In order for an FSLEE application 18 to decode the TCAP message properly when the TCAP message is sent by FSL IP Gateway 10, the TCAP message may be described in a Message Definition File (MDF). The MDF contains a message corresponding to that created by the FSL IP Gateway 10, so that FSL can tokenize the message and present the message to the FSLEE application 18.

The Operation Handling File specifies to the FSL IP Gateway 10 the application (e.g., FSLEE application 18) to invoke upon receipt of a specific message. This file is used to invoke the application that will respond to a message from FSL IP Gateway 10 by matching the operation code in the Operation Handling File with the OPERATION-CODE parameter of the FSL IP Gateway 10:

An Application Context Map File maps an Object Identifier (OID) into a set of configurations used by FSL to process a set of messages. The OID is converted into a number; that number is present in each message which is part of that message set. The Application Context Map File contains the OID, but the FSL IP Gateway 10's APP-CONTEXT parameter is the number which is to be put into the message. The OID can be converted into the parameter using this algorithm:
A. Take the first number in the OID and multiply the first number by 4.
B. Add the second number. The result of this addition is the first number of the parameter.
C. For every other number (from the third to the last), append them as hexadecimal numbers to the number created in step B.
   As an example, consider this Application Context Map File:
# The Application Context for this dialogue is:
# {TCAP(0) MTS interface(1) Prepay/FSL(0) system(0) INS platform(1)
# FSL-to-Prepay(1) version(0)}, Prepay/FSL
# In octets this is <01000001000100>
{0, 1, 0, 0, 1, 0, 1, 0}, PREPAY
   The OID in this file is {0, 1, 0, 0, 1, 0, 1, 0}. The parameter converted from this OID is 01000001000100. This parameter is converted from this OID as follows:
1. Per steps A and B above, (0*4)+1=1 (or 01 in hexadecimal)
2. Per step C above, 00 00 01 00 01 00, the next six digits expressed as hexadecimal.

Several parameters determine how the FSL IP Gateway 10 handles connections to the IP network:

| Parameter | Description |
|---|---|
| TCPIP-PROCESS-NAME | The name of the TCP/IP process which |
| | FSL IP Gateway 10 should use to establish |
| | TCP communications. |
| CONNECTION-TIMEOUT | The number of seconds to wait for an idle |
| | communications pipe to close before forcibly |
| | closing the communications pipe. |

If the FSL IP Gateway 10 will not be run under the node, three parameters are provided so that the FSL IP Gateway 10 can interact with other processes. When run under the node, these parameters are provided by INS.

| | |
|---|---|
| CSS-MM-NAME | The name of the Memory Manager process (usually |
| | “MM?*”, where “?” is replaced with the CPU, and |
| | “*” with the node designator which FSL IP |
| | Gateway 10 needs to communicate in). |
| CSS-MM-TASKID | A task ID for FSL IP Gateway 10 to use when |
| | communicating with other processes |
| CSS-MM- | A server class for FSL IP Gateway 10 to use when |
| SVRCLASS | communicating with other processes. |

The foregoing description provides illustration and description, but is not intended to be exhaustive or to limit the invention to the embodiments disclosed. Modifications and variations are possible consistent with the above teachings or may be acquired from practice of the embodiments disclosed. Therefore, it is noted that the scope is defined by the claims and their equivalents.

1. A method for implementing Internet Protocol (IP) to transaction capabilities part (TCAP) communications, comprising:
receiving a hypertext transport protocol (HTTP) request from a HTTP client;
decoding the HTTP request;
wrapping the decoded HTTP request in a TCAP message;
determining an appropriate destination flexible service environment (FSLEE) application for the HTTP request; and
forwarding the wrapped HTTP request to the destination FSLEE application.

2. The method of claim 1, further comprising:
listening on an IP port for the HTTP request.

3. The method of claim 1, further comprising:
receiving a response from the destination FSLEE application;
wrapping the response in a HTTP header; and
sending the wrapped response to the HTTP client.

4. The method of claim 1, wherein the HTTP request is a HTTP PUT request.

5. The method of claim 1, further comprising:
wrapping the decoded request in a TCAP message.

6. A computer-readable medium comprising instructions for:
receiving a hypertext transport protocol (HTTP) request from a HTTP client;
decoding the HTTP request;
wrapping the decoded HTTP request in a TCAP message;
determining an appropriate destination flexible service environment (FSLEE) application for the HTTP request; and
forwarding the wrapped HTTP request to the destination FSLEE application.

7. The computer-readable medium of claim 6, further comprising instructions for:
listening on an IP port for the HTTP request.

8. The computer-readable medium of claim 6, wherein the computer-readable medium is a memory resident in a host server.

9. The computer-readable medium of claim 8, wherein the FSLEE application is resident on the host server.

10. A method for implementing Internet Protocol (IP) to transaction capabilities part (TCAP) communications, comprising:
receiving a flexible service environment (FSLEE) application message from a FSLEE application;
determining an appropriate destination Internet Server for the FSLEE application message;
opening a connection with the destination Internet server; and,
forwarding the FSLEE application message to the destination Internet server.

11. The method of claim 10, further comprising:
waiting for the FSLEE application message.

12. The method of claim 10, further comprising:
receiving a response from the destination Internet server;
wrapping the response in a TCAP message; and,
sending the wrapped response to the FSLEE application.

13. The method of claim 10, wherein the Internet server is a transmission control protocol/internet protocol (TCP/IP) server.

14. A computer-readable medium comprising instructions for:
receiving a flexible service environment (FSLEE) application message from a FSLEE application;
determining an appropriate destination Internet Server for the FSLEE application message;
opening a connection with the destination Internet server; and
forwarding the FSLEE application message to the destination Internet server.

15. The computer-readable medium of claim 14, further comprising instructions for:
waiting for the FSLEE application message.

16. The computer-readable medium of claim 14, wherein the computer-readable medium is a memory resident in a host server.

17. The computer-readable medium of claim 16, wherein the FSLEE application is resident on the host server.

18. A method for implementing Internet Protocol (IP) to transaction capabilities part (TCAP) communications, comprising:
receiving a message from an Internet server;
determining appropriate destination flexible service environment (FSLEE) application for the message;
wrapping the message in TCAP message; and
forwarding the wrapped message to the destination FSLEE application.

19. The method of claim 18, further comprising:
listening on an IP port for a message from an Internet server.

20. The method of claim 19, further comprising:
receiving a response from the destination FSLEE application; and
sending the response to the Internet server.

21. The method of claim 18, wherein the Internet server is a transmission control protocol/internet protocol (TCP/IP) server.

22. A computer-readable medium comprising instructions for:
receiving a message from an Internet server;
determining appropriate destination flexible service environment (FSLEE) application for the message;
wrapping the message in TCAP message; and
forwarding the wrapped message to the destination FSLEE application.

23. The computer-readable medium of claim 22, further comprising instructions for:
listening on an IP port for a message from an Internet server.

24. The computer-readable medium of claim 23, wherein the computer-readable medium is a memory resident in a host server.

25. The computer-readable medium of claim 24, wherein the FSLEE application is resident on the host server.

26. A system for implementing Internet Protocol (IP) to transaction capabilities part (TCAP) communications, comprising:
one or more flexible service environment (FSLEE) applications;
one or more Internet servers;
one or more hypertext transport protocol (HTTP) clients; and
a FSL IP gateway, in communication with the FSLEE applications, the Internet servers and the HTTP clients, comprising instructions for operating in one of a first mode that enables communications between the FSLEE application and the HTTP clients, and a second mode that enables communications between the FSLEE application and the Internet servers.

27. The system of claim 26, wherein the FSL IP gateway operates in the first mode by executing instructions for:
receiving a HTTP request from one of the one or more HTTP clients;
decoding the HTTP request;
determining which of the one or more FSLEE applications is an appropriate destination FSLEE application for the HTTP request;
wrapping the decoded request in a TCAP message; and
forwarding the wrapped request to the destination FSLEE application.

28. The system of claim 26, wherein the FSL IP gateway operates in the second mode by executing instructions for:
receiving waiting for a FSLEE application message from one of the one or more FSLEE applications;
determining which of the one or more Internet servers is an appropriate destination Internet server for the FSLEE application message; and
forwarding the FSLEE application message to the destination Internet server.

29. The system of claim 26, wherein the FSL IP gateway operates in the second mode by executing instructions for:
receiving a message from one of the one or more Internet servers;
determining which of the one or more FSLEE applications is an appropriate destination FSLEE application for the message;
wrapping the message in a TCAP message; and
forwarding the wrapped message to the destination FSLEE application.

30. The system of claim 26, wherein the FSL IP gateway is resident on a host server.

31. The system of claim 30, wherein the one or more FSLEE applications are resident on the host server.

32. The system of claim 26, wherein the Internet servers are transmission control protocol/internet protocol (TCP/IP) servers.
